(19) United States
(12) Patent Application Publication
(10) Pub. No.: US 2007/0186130 A1
(43) Pub. Date: Aug. 9, 2007

(54) Reduced size transmission data packet header format for a medical device

(75) Inventors: Per Einar Pontus Holm, Tygelsjo (SE); Per Hvid Hansen, Lynge (DK); Morten Stribaek, Frederiksberg (DK)

Correspondence Address: NOVO NORDISK, INC.;PATENT DEPARTMENT, 100 COLLEGE ROAD WEST, PRINCETON, NJ, 08540, US

(73) Assignee: Novo Nordisk A/S, Bagsvaerd (DK)

(21) Appl. No.: 11/522,831

(22) Filed: Sep. 18, 2006

Related U.S. Application Data
(63) Continuation of application No. PCT/DK05/00025, filed on Jan. 17, 2005.

(30) Foreign Application Priority Data
Mar. 19, 2004 (DK) PA 2004 00444

(51) Int. Cl. G06F 11/00

(52) U.S. Cl. 714/701

(57) ABSTRACT

The present invention relates to a reduced size format for transmission packet header wherein a source address is encoded together with a check code in a medical device. The packet header thus contains one single field now in place of two i.e. the check code and source address. At the receiving end, the receiver looks up the sender address from the session descriptor table, calculates the check code and then performs the same encoding with the address and the check code, thus authenticating and validating the packet.

The present invention relates to the field of packet-switched data communication devices. More specifically the invention relates to the size and format of packet headers used during the transmission of data between two or more medical devices.

Networking involves information transfer between two remote machines/users. Some well known networks include Postal (non electronic), telegraph (first digital electronic network), Telephone, Broadcast (television and telephone) and the Internet. For any two parties to effectively communicate (including humans, computers etc.) they have to follow a certain protocol. This protocol identifies a set of rules and guidelines which the parties use to communicate with each other.

Networks can be classified by the manner in which data is transmitted. Two popular classifications are circuit switched and packet switched network. Switched networks involve a partially or fully meshed topology (i.e. partial or total connection between the nodes of the network) and use special network devices called switches to interconnect the links between source and destination nodes.

In a circuit switched network, a physical circuit is first established between the source and the destination before any transmission takes place. Once established, the circuit is dedicated exclusively to the current transmission. After the transmission is complete, this circuit is then released and made available for another communication transmission.

In a packet switched network, messages are first partitioned into smaller units called packets, which are then sent to the destination nodes via intermediate switches. A packet is the smallest unit of data that can be transferred within a given network. Each packet header typically carries destination node address, source address as well as other important information like protocol specific information, sequence number, length of data bytes etc.

A comparison of the two, i.e. packet switched and circuit switched network, appears through the following table:

| Property | Circuit Switching | Packet Switching |
|---|---|---|
| Route Selection | Static | Dynamic (per packet) |
| Possible Reordering | No | Yes |
| Response to link failure | Data Loss | Rerouting/Retransmission |
| Delivery | Guaranteed | Depends on network |

Packets are generally built with the following layers:
Application layer (FTP, HTTP, SMTP, etc.)
Transport layer (TCP, UDP)
Internet Layer (IP)
Network Access Layer (Ethernet, ATM, etc.)

These layers are the different levels of the networking protocol, and the combined set of protocol between each pair of communicating layers is the so called protocol stack.

As a packet typically is encapsulated, each layer takes the data (body) from the previous layer and adds a header to it. Correspondingly, at the receiving end, each layer removes the header and accesses the data/body in it and sends it to the next layer, etc.

Packets may have a uniform hardware independent format. They typically include Header and Data. The sizes of Header and Data may vary, but usually the size of the Data is much larger than the Header. The Header typically contains all information necessary to deliver a packet to the destination end, i.e. said information may comprise:
Source address,
Destination address,
Identifier, and
Other control parameters.

The device that directs packets in the network layer is called a router. The router checks the address and forwards the packet to the correct path. A router's task is to interconnect physically different networks, and to route packets from one network to another. The router determines a certain path to a destination node and then sends the packet according to this path.

The important considerations while dealing with networking typically include:
packet security,
data validity,
packet authentication,
network congestion, traffic

Different ways exist to secure data security, for example encryption of data in the sender. In such a case, data is of course encrypted such that only the receiver can decrypt the data.

The header of a packet typically includes a check code that is calculated using the packet data. At the receiving end, the receiver operates on the check code and on the basis of the result obtained, it can be checked whether the packet with a correct content has arrived. Thus data validity is achieved.

The basic way in which packet authentication is achieved is that prior to any data exchange between two or more communicating parties, each of these is assigned a unique address, if they do not have one already. These devices then exchange their corresponding addresses with one another. Thereafter any communication occurring between these devices also identifies the originator (i.e. source) of the data packet. The receiver can then check if the packet is from the expected transmitter and, in that case the receiver can carry on with other processing relating to data.

Congestion may occur in a network device when packets arrive faster than they can be forwarded. Since switches have large number of inputs (which may regularly have packets destined for a single output), switches often cause network congestion.

Traffic means the data volume that flows through the network. Heavy network traffic may also result in a communication overload. This becomes very time consuming for those accessing the network. The traffic density of the network can be reduced either by reducing the number of packets travelling or by decreasing the amount of data in the packets

U.S. Pat. No. 6,516,344 discloses a system for reducing network traffic by keeping track of unallocated regions in files. The system receives requests at a local computer system for access to a file on the remote server. If the request is a read operation and the operation is directed to an unallocated region of the file on the remote server, the system returns a block of null values to the requestor without receiving the block of null values from the remote server, thus avoiding unnecessary traffic load. A similar approach is followed for a write request.

U.S. Pat. No. 6,622,173 discloses a method for reducing traffic by an automatic message prediction system operable in a communications system including a transmitter and a receiver. The receiver receives at least a portion of a message and tries to identify from the message portion, a message previously received by the receiver. If successful, the receiver calculates a checksum for the previously received message and transmits the checksum as a prediction of the remainder of the message to the transmitter. On receipt from the transmitter of an indication that the prediction is correct, the receiver completes the message from the previously received message. The approach although effective, has the drawback of requiring an additional storage capacity to maintain a backup of the previously received messages. Further, the calculation involved increases the need for computational resources.

U.S. Pat. No. 6,359,877 discloses a method and apparatus provided for minimizing overhead in packet re-transmission in a communication system. It uses the concept of varying the packet size. The packet size may be adapted based on the transmission rate and/or throughput, whether the packet is being transmitted the first time or re-transmitted. Alternately, if the packet is being re-transmitted, the packet is transmitted at its original transmission rate. In this apparatus, the packet size needs to be considered for every transmission requiring an overhead of computational resources.

European Patent Number 1,261230 discloses a method for reducing overhead by allowing the removal of HEC (Header Error Correction). But this method is applicable only where the physical layer of the transmission stacks offers powerful error correction schemes.

U.S. Pat. No. 6,041,351 discloses an invention to reduce network congestion by reducing interprocessor instruction size. The data packets are stored representatively in a MRU memory cache, and thus it is avoided to retransmit of one or more packets representing the same data packet. This invention needs to maintain a separate cache memory which increases the cost.

International Publication No. WO 99/27751 discloses a method in which the useful data can be transmitted in a minimum number of bytes within data packets. The approach adapted of this publication is of replacing pattern of bits and bytes with allocated symbols. This approach increases the data transmitted in the existing data payload part but does not take any step towards reducing the header size as to increase the data payload part.

Thus, there is need for a methodology wherein the packet size has greater capacity for data payload and a header component that by itself contains all the required information for authentication as well as for data validation.

It is an object of this invention to overcome the drawbacks of the prior art by providing a method for reducing packet header size that ensures data validity and authentication.

It is another object of the present invention to enable higher data payloads in each packet.

It is also an object of the present invention to reduce the communication overhead in a packet transmission system and to reduce network congestion and traffic.

To overcome the drawbacks of the prior art and to achieve the aforementioned objectives, the present invention provides a method for reducing the packet header size. According to the present invention, the source address is encoded together with the check code of the data packet, thereby reducing the size of the transmission header. This is implemented by applying one or more mathematical operations. The receiver computes the check code using the received data and after looking up for the remote address, the receiver encodes it and the address using the same mathematical function/s. If the computed check code does not match with the received one, the packet is skipped. Conversely, if the computed check code matches the received one, the packet is accepted.

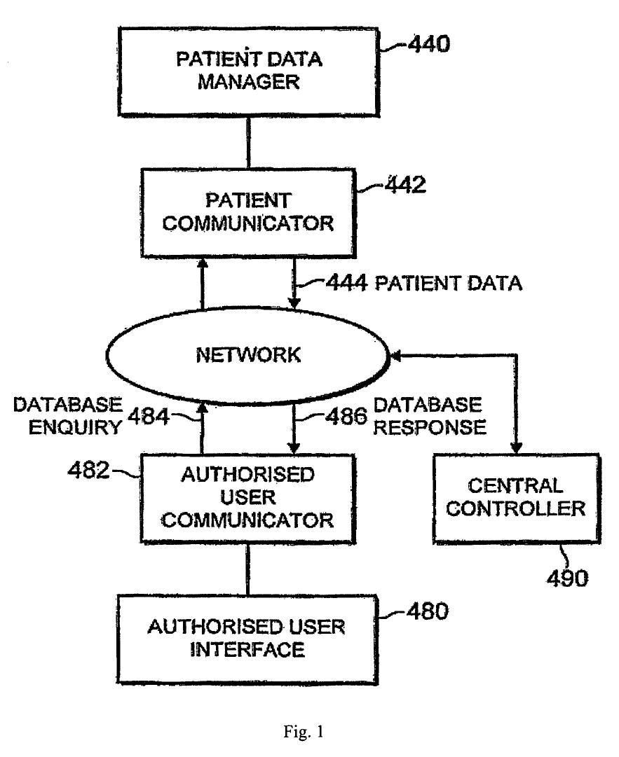

FIG. 1 shows a medical device in the context of which this invention is explained.

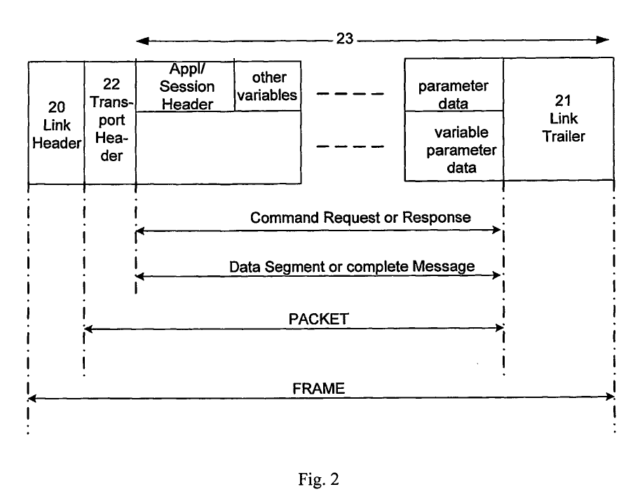

FIG. 2 exhibits a transmission packet.

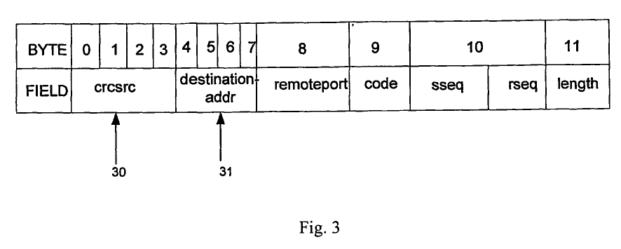

FIG. 3 shows a transmission packet header.

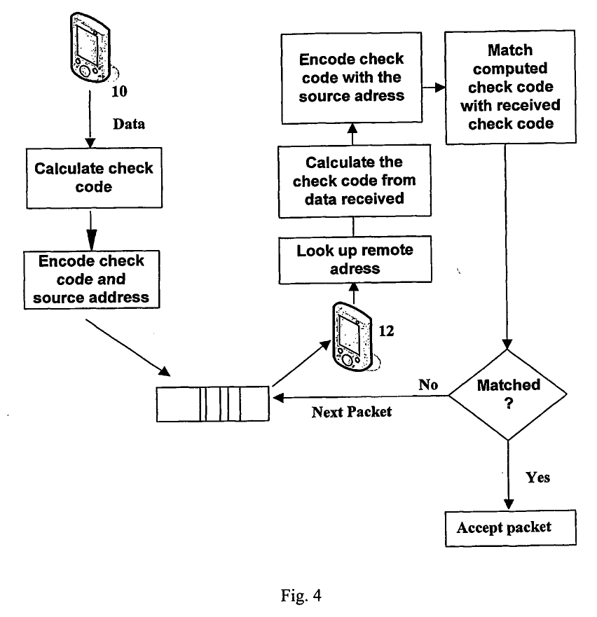

FIG. 4 illustrates a flow diagram describing how the method works.

The present invention provides a method for reducing packet header size to allow a higher data payload in each packet while providing data validity and authentication possibilities.

According to the present invention, a packet header could contain a field, in addition to the destination address and other control parameters, which could contain the check code encoded together with the source address. The field is placed in the packet header as a substitution for the source address and check code together. This may avoid the need to add the source address separately for proper authentication of the packet. Encoding can be achieved using any of known mathematical operations. In broadcast, where there is no single point to point connection intended since a packet is addressed to all the available receivers in the network, this field in the packet header could contain only the raw check code. The destination address could be a worldwide unique device ID.

The present invention can be carried out in any packet switched network. The network can be wired network like the Internet or wireless network like wireless Ethernet. The network can be secure, insecure, private, public or a combination of these. The generic packet format described herein can be implemented over any protocol like File Transfer Protocol (FTP), Transmission Control Protocol (TCP), and Bluetooth, etc. The network topology, such as bus, star, ring etc., or data transfer forms, such as duplex, simplex, etc do not influence the application of this invention. The method is equally applicable to computer networks as well as telecommunication networks and any other network wherein digital data is to be transmitted.

There are numerous applications of the present invention and the explanation of FIG. 1, is meant just as an illustration and in no case is meant to be limiting. For instance the present invention is equally effectively applicable for secure transaction over the Internet as well a network of medical devices, in the context of which the application of the invention now will be explained.

International Publication Nos. WO 00/32088, WO 03/005891 and WO 03/015838 all describe such medical devices, networks and method of their operation along with some of the possibilities in the domain. We shall very briefly touch upon such device incorporated herein as reference.

FIG. 1 is an illustration of one of the medical devices comprising an electronic data manager as disclosed in International Publication No. WO00/32088 which is incorporated herein as a reference. Shown is a system which comprises an electronic patient data manager 440. Associated with the patient electronic data manager 440, is a patient communicator 442 which is responsible for transmitting the data with the patient electronic data manager whenever the patient wishes, or periodically. The patient communicator 442 communicates with a network communication system 450. The system also provides a user interface 480 that is capable of communicating with the network communication system. Central controller 490 is a two-way communication channel with the network communication system. The figure also illustrates the patient data 444 being wirelessly communicated from patient data manager 440 to the network. A patient can also request for some data though the network and receive responses via the patient communicator 442 and patient data manager 440. A database enquiry 484 can be made and response 486 received through via the authorized user communicator 482 to the authorized user interface 480.

The present invention may be applied in a medical device, such as a pump, a syringe, a doser or any other electronic device able of communicating data in packets with other electronic devices, which may be of the same kind as the device initiating the communication. As an example the medical device may be the electronic data manager as discussed above.

In the present context, the term ‘medical device’ can mean an injector type device (such as a pen injector or a jet injector) for delivering a discrete dose of a liquid medication (possibly in the form of small drops), a medication pump for continuous delivery of a liquid medication, an inhaler, spray or the like for delivering a discrete or continuous dose of a medication in vaporized, ‘atomized’ or pulverized form, preferably the medication is insulin. The medical device can also mean a blood glucose tester or a BGM (blood glucose measurement device), e.g. a device using so-called test-strips for the manual measurement of the glucose level in the blood or a more advanced device, i.e. a CGM (continuous glucose measurement device) performing automatic continuous measurements of the blood glucose level.

U.S. Pat. No. 6,540,672, U.S. Pat. No. 6,656,114, US2002010432 and US2003032868 all disclose intelligent medical devices, which are hereby incorporated by reference in its entirety. U.S. Pat. No. 5,888,477 (which is hereby incorporated by reference in its entirety) discloses an inhaler with robust features that may be used for insulin delivery. U.S. Pat. No. 5,785,049 to Smith et al (which is hereby incorporated by reference in its entirety) discloses a device suitable for powdered medication delivery.

FIG. 2 illustrates a framed transmission packet. A packet, prior to being sent, is framed with a link header and a link trailer. The link header 20 and link trailer 21 denote the beginning and end of the packet, respectively. The link header and trailer each may have a predetermined sequence of bits, thus the receiver can then easily identify the beginning and end of the packet. The transport header or the transmission header 22 may carry the source address, destination address and the check code. The length of the transport header 22 may be 12 bytes as an exemplary embodiment of the invention. According to the present invention, the source address and the check code are encoded together thus reducing the header size. This can further be advantageous since the saved size can be used to increase a size of the data payload 24, thus letting the total packet size remain unaffected, or the saved sized may be simply applied to reduce the total packet size.

FIG. 3 shows a transmission packet header. According to the present invention, a packet header may contain a field 30, in addition to the destination address 31 and other control parameters, which may contain the check code encoded together with the source address. This can avoid the need to add the source address separately for proper authentication of the packet. The field 30 is placed in the packet header as a substitution for the source address and check code. Encoding can be achieved by using any mathematical operation dedicated to that purpose. During broadcast, in the case where there is no connection because a packet is addressed to all the devices (i.e. destinations) in the network, this field in the packet header may contain only the raw check code, since in that case there is no need for the destination address. If it is not a case of broadcasting, but a point to point communication i.e. sending information from a sender (source) to a receiving device (destination), the destination address may as an example be a unique device ID identifying the receiving device uniquely.

In a preferred embodiment, the process of XOR-ing the check code with the source address may be used to compute the additional field(s) in the packet header.

In addition to above fields, a packet header may contain bit-length of the packet, sequence number, remote port, code, etc.

FIG. 4 illustrates a flow diagram that describes how the present invention works at the source end and the destination end. At a starting point, a wireless medical device 10 sends data that is encapsulated into packets. The packet header may conventionally contain the sender address and also the check code along with other fields. The data payload is used to calculate check code according to any known algorithm. It is then encoded, e.g. XORed, with the source address. Any logical/mathematical operation other than the mentioned XORing may also be applied. Each of the check sum and the source address may be of a different and/or of a predetermined length. Those, i.e. the check sum and the source address, altogether are transmitted. At the destination end, the second wireless medical device 12 cannot authenticate the packet without looking at the source address. It may look up for the remote address in its session descriptor table. The data is then used to calculate the check sum. The calculated check sum is encoded with the looked up remote address. The encoded output should now be the same as the received figures in the packet header, if this is not the case, the packet will not be accepted by the second wireless medical device 12.

In a preferred embodiment, the check code and the source address may be XOR'ed together and substituted in place of the source address and the check code.

The aforementioned method can be implemented using a set of instructions being run on a computing device in the form of hardware or software or in a combination of both. The present invention is independent of the language and the codification used in the implementation of the above method at various levels of abstraction.

In general, the computing device or device can be any general computing device having processing means, control unit, storage means and internal communication means, as an example any of said devices may be the medical device as previously discussed, i.e. it may be a pump, a pen, a syringe, a doser, etc.

As an example, in the very simple case, the devices can establish a single connection (here, the remoteport number is fixed to 1). In the more complex scenario, the devices can have multiple simultaneous connections, controlled via “port numbers”.

When a connection is established, device addresses (i.e. destinations) are exchanged. A connection can be deleted and a new connection may be established again to another device (without the other device “knowing” this), so it may happen that one device has a “stalled” session connection. This can be illustrated by way of the following example: Device A and device B has a connection. Device B is turned off or for some other reason is not able to communicate, e.g. it may be out of a radio communication reach. Device A then deletes its connection and establishes a new connection to device C. If device B later on “wakes up” and comes into radio reach again, it may start to send data to device A on the old connection which device B still assumes is valid. Device A has no way of knowing that the packet originates from the deleted connection to device B, so it will think the packet originates from the new connection to device C. The reason for this potential hazard is when the packet header does not uniquely identify the sender (source). The simple way of fixing this problem is to include the source address, (then encoding it, etc as already discussed) in the header as disclosed in the present invention. Thus, the present invention devises a way to include the source address in the header, without increasing the header size in the protocol applied.

The rationale behind the idea of the present invention is that a wireless protocol for very low end medical devices should provide both a high level of data validity and some authentication mechanism while keeping the packet header size—as discussed—as small as possible.

During connection establishment, the two devices exchange source addresses. Once the connection has been established, all further communication between the devices (except for broadcast messages) contains a CRC32 where the source address as an example may be XOR'ed onto the frame CRC. The receiver can then look up the remote address in its session descriptor table, and if the computed CRC does not match the received CRC (after XOR'ing with the remote address from the descriptor table) the frame will be skipped, conversely the frame is accepted allowing further processing of data contained in the frame. Thus, a device will only accept packets on the connection if they originate from the correct sender (i.e. source).

The CRC computation and source address validation may of course be implemented in hardware as well as in software or in combinations thereof.

1. A transmission packet header format for packets exchanged in a communication network comprising medical devices, characterized in that said packet header includes a field comprising a check code encoded together with a source address.

2. The format of claim 1, wherein said check code includes Cyclic Redundancy check (CRC) code.

3. The format of claim 1, wherein said source address and said check code are encoded together using any known mathematical algorithms.

4. The format of claim 1, wherein said source address and said check code are optionally encoded together using a hardware circuit.

5. A communication protocol for a communication network, comprising medical devices, for reducing the packet header size characterized in that said protocol encodes together a check code and a source address.

6. A method for reducing the packet header size of the packets exchanged in a communication network including at least one transmitting device and at least one receiving device, said devices are medical devices, said method characterized in the steps of:
said transmitting and receiving devices exchanging their addresses,
said transmitting device calculating a check code for the transmission packet,
encoding together the said check code with the transmitting device's address, and
including the encoded result in said packet header.

7. The method of claim 6, wherein said check code includes (CRC) code.

8. The method of claim 6, wherein said encoding includes any known mathematical algorithms.

9. The method of claim 6, wherein said transmitting device's address and said check code are optionally encoded together using a hardware circuit.

10. A computer program product comprising computer readable program code stored on a computer readable storage medium embodied therein for reducing the packet header size, comprising:
computer readable program code means configured for computing a check code,
computer readable program code means configured for encoding together said check code and a source address, and
computer readable program code means configured for framing the encoded results with the packet header.

11. A method for reading data packets received, constructed in accordance with the format or method as described in claim 1, said method, implemented by the receiver, comprising the steps of:
said receiver looking up a remote address in its session descriptor table,
calculating a check code using data received,
encoding said remote address together with said calculated check code,
matching said encoded output with the check code, and
skipping the packet if negative match, else accepting it.

12. The method according to claim 11, wherein said check code is calculated in the same manner as at the sender end.

13. The method according to claim 11, wherein the encoding of said remote address with said check sum use same algorithm as at the sender end.

14. A computer program product comprising computer readable program code stored on a computer readable storage medium embodied therein for reading the packets received, comprising:
computer readable program code means configured for looking up a remote address in a session descriptor table
computer readable program code means configured for calculating a check code using data received,
computer readable program code means configured for encoding said remote address together with said calculated check code,
computer readable program code means configured for matching said encoded output with the check code, and
computer readable program code means configured for skipping the packet if negative match, else accepting it.
